(19) United States
(12) Patent Application Publication
(10) Pub. No.: US 2022/0268507 A1
(43) Pub. Date: Aug. 25, 2022

(54) TEMPERATURE CONTROLLED STORAGE CONTAINER

(71) Applicant: B MEDICAL SYSTEMS S.Á.R.L., Hosingen (LU)

(72) Inventors: RENE GANSEN, Ammeldingen (DE); Andreas HOFFMANN, Ammeldingen (DE)

(21) Appl. No.: 17/623,069

(22) PCT Filed: Jun. 29, 2020
(86) PCT No.: PCT/EP2020/068311

§ 371 Date: Dec. 27, 2021

(30) Foreign Application Priority Data
Jun. 27, 2019 (GB) 1909276.6

(51) Int. Cl. F25D 3/08

(52) U.S. Cl. CPC F25D 3/08; B65D 81/3816

(57) ABSTRACT

A passive cold storage container, notably a vaccine transport container, comprises: —a product storage compartment (11); —one or more ice-pack compartment(s) (14-17) arranged adjacent to the product storage compartment, the ice-pack compartment(s) being spaced from the product storage compartment by a thermal barrier (26-30); and —a thermally insulated envelope (18) surrounding the product storage compartment and the ice-pack compartment(s). The thermal barrier comprises a phase change material having a solid/liquid transition temperature which is ≥1.0° C. and ≤10° C. The configuration provides user-independent freeze-free protection.

This invention relates to a temperature-controlled storage container, notable a vaccine carrier.

To ensure their quality, longevity and effectiveness, vaccines must be stored and transported at an optimum storage temperature, generally ≥+2° C. and ≤+8° C.

Exposure to higher or lower (particularly freezing) temperatures causes deterioration of the vaccines. Consequently, vaccines are generally stored in specialised vaccine refrigerators at vaccine storage facilities or at heath centres where immunisation programs are carried out.

A particular issue arises for outreach programs, that is to say, part of a vaccination program generally run in a developing country where the vaccination is carried out at a village or other location which is remote from a health centre. The vaccines must be removed from the specialised vaccine refrigerators, for example at a health centre, and transported to the outreach centre for use. In order to maintain continuity of the temperature of the vaccines between ≥0° C. and ≤+10° C., and preferably between ≥+2° C. and ≤+8° C., the vaccines are transported in insulated storage containers, sometime known as passive vaccine containers or passive vaccine carriers, provided with pre-frozen ice-packs. The term “passive” container or carrier is used to indicate the absence of a powered cooling circuit, for example an electrically powered compressor which circulates a cooling fluid through an evaporator. The term “ice-pack” as used herein indicates a plastics, leak proof container containing water (generally tap water) which is frozen before use, and which preferably complies with WHO specification PQS/E005/IP01; ice-packs serve to absorb heat and thus control temperature when arranged within a passive vaccine container. Such ice-packs are generally prepared by being frozen in a specialised freezer operating at a temperature of −20° C. or more generally −25° C. Precautions are taken to reduce the risk of the ice-packs causing freezing of the vaccines within the vaccine carriers, for example, by ensuring a physical separation within the vaccine carriers so that vaccines are not in direct contact with the ice-packs. In addition, it has generally been necessary to impose a protocol for use of passive vaccine carriers requiring conditioning of the frozen ice-packs before they are placed within a vaccine carrier. This conditioning requires the user to remove the frozen ice-packs from their freezer, to subsequently allow the ice-packs to remain at room temperature before loading into the vaccine carrier, for example to remain at room temperature for a fixed duration or until the ice-packs reach a pre-determined temperature or until water can be heard to swill within the ice-pack when shaken, and only once the conditioning has been completed to load the ice-packs into the vaccine carrier. The requirement for conditioning of the ice-packs can cause considerable delay, often of a number of hours. Furthermore, compliance with a protocol for conditioning of ice-packs is a source of potential user error which can lead to undesired freezing and loss of potency of vaccines.

Previous proposals for user-independent freeze-preventive vaccine carriers to obviate the need for conditioning of ice-packs have failed to resolve the combination of often contradictory requirements. For example, the use of cool water packs instead of ice-packs a) significantly reduces the cold life (i.e. the duration for which the temperature is maintained below its permissible maximum) unless a significantly greater mass of water is used and ii) requires new refrigerators for cooling the water packs to replace to existing freezers for ice-packs. Substitution of ice-packs by pre-frozen paraffin-based coolant packs engineered to have a melting temperature above 0° C. significantly reduces cold life in addition to raising issues of product safety if leaks occur and end of life disposal. Proposals for the provision of a freeze-preventive sleeve of water or salt water between the ice-packs and a vaccine storage compartment adds weight, reduces vaccine carrying capacity and raises issues of inspection for correct configuration and absence of leaks.

In accordance with one of its aspects, the present invention provides a passive cold storage container in accordance with claim 1. Other aspects are set out in other independent claims. The dependent claims define preferred or alternative embodiments.

The volume of the product storage compartment may be ≥0.5 litre ≥0.8 litre ≥1.0 litre, ≥1.5 litre or ≥2.0 litre and/or ≤5.0 litre, ≤4.0 litre, ≤3.5 litre or ≤3.0 litre; this provides a suitable storage space for the products, notable vials of vaccines, whilst allowing for a configuration that has a desirable cold life without excessive weight.

Cold storage containers having such product storage compartments preferably have a loaded weight which is ≤15 kg, ≤12 kg, ≤10 kg or ≤8 kg. Alternatively, the volume of the product storage compartment may be: >5.0 litre and/or ≤10.0 litre; >10.0 litre and/or ≤15.0 litre; or >15.0 litre and/or ≤35.0 litre.

Particularly when it is a vaccine storage container, the cold storage container may have:

a) a cold life ≥15 hours at +43° C.—this is particularly suitable for short range vaccine carriers; such a cold storage container may have a loaded weight ≤7.0 kg and/or a vaccine storage capacity ≥0.5 litres; and/or
b) a cold life ≥30 hours at +43° C.—this is particularly suitable for long range vaccine carriers; such a cold storage container may have a loaded weight ≤8.0 kg and/or a vaccine storage capacity ≥1.0 litres.
As used herein the term “loaded weight” means the weight of the passive cold storage container including the weight of its ice-packs.
The cold life is determined in the following way:
Test conditions: Stabilize the test chamber at +43° C. (±0.5° C.). Condition the cold storage container in the test chamber for 24 hours with the door or lid of the cold storage container open. Record conditions at the time of the test.
Step 1: Assemble a dummy vaccine load comprising partially water-filled, glass vaccine vials (10 to 50 mL vials are recommended) with a combined density of 0.06 kg of water per litre of the vaccine storage capacity. Stabilize the load in a cold room or refrigerator at +5° C. (±0.5° C.) for a minimum of 24 hours.
Step 2: Fully freeze the ice-packs for which the cold storage container is configured to −25° C. (±0.5° C.). Transfer the frozen ice-packs directly from their freezer to the cold storage container (without conditioning) as quickly as possible and within at most 3 minutes of being removed from the freezer, and arrange an ice-pack in each ice-pack compartment of the cold storage container. Place the +5° C. load in the vaccine storage compartment together with suitable temperature sensors. Ensure that the sensors do not touch the adjacent ice-packs. Close the lid of the container.
Step 3: Monitor temperatures of the vaccine storage compartment at one minute intervals until the temperature of the warmest of the sensors first reaches +10° C. (after initially cooling to below +10° C. during cooldown).
The cooldown is defined as the time interval from the moment when the lid of the container is closed until the temperature of the warmest point in the vaccine storage compartment first goes below +10° C. The cold life is defined as the time interval from the moment when the lid of the container is closed until the temperature of the warmest point first reaches +10° C. after initially cooling to below +10° C.

Preferably, the cold storage container is a Grade A (user-independent) freeze protected storage container as defined by the World Health Organisation PQS requirements in force on 1 Jun. 2019.

The cold storage container is preferably a user-independent freeze-free container (i.e. the temperature in the product storage compartment does not fall below 0.0° C.) when tested at 15° C., and preferably when tested at 20° C., in the following way:

Test conditions: Stabilize the test chamber at +15° C. (±0.5° C.). Condition the cold storage container in the test chamber for 24 hours with the door or lid of the cold storage container open. Record conditions at the time of the test.
Step 1: Assemble a dummy vaccine load comprising partially water-filled, glass vaccine vials (10 to 50 mL vials are recommended but are not required) with a combined density of 0.06 kg of water per litre of the vaccine storage capacity. Stabilize the load in a cold room or refrigerator at +5° C. (±0.5° C.) for a minimum of 24 hours.
Step 2: Fully freeze the ice-packs for which the cold storage container is configured to −25° C. (±0.5° C.). Transfer the frozen ice-packs directly from their freezer to the cold storage container (without conditioning) as quickly as possible and within at most 3 minutes of being removed from the freezer, and arrange an ice-pack in each ice-pack compartment of the cold storage container. Place the +5° C. load in the vaccine storage compartment together with suitable temperature sensors. Ensure that the sensors do not touch the adjacent ice-packs. Close the lid of the container.
Step 3: Monitor temperatures in the vaccine storage compartment at one-minute intervals as the temperature in the vaccine storage compartment initially decreases and subsequently increases.

The ice-packs may have a volume which is ≥0.2 litre and/or ≤0.4 litre or which is ≥0.5 litre and/or ≤0.7 litre. Preferably each ice-pack has a volume of about 0.6 litre±0.05 litre. Alternatively, each ice-pack may have a volume of about 0.3 litre±0.05 litre or about 0.4 litre±0.05 litre. The cold storage container may be configured to operate with two, three or four ice-packs. The number of ice-packs is selected as a function of the size of the cold storage container and the desired cold life. For example; a cold storage container having a 7 litre product storage compartment and a cold life of at least 100 hours at +43° C. may be provided with 14 0.6 l ice-packs; and a cold storage container having a 20 litre product storage compartment and a cold life of at least 120 hours at +43° C. may be provided with 24 0.6 l ice-packs. Preferably, each ice-pack compartment is configured to retain an ice-pack in a fixed position within the container. In configurations of use, each ice-pack compartment contains an ice-pack.

The phase change material preferably comprises particles of paraffin, wax or other organic materials which are physically retained by a polymer or fibre network, for example a woven or non-woven network of polymeric fibres, when present in a liquid state and when present in a solid state. One preferred form of phase change material is that disclosed in U.S. patent application Ser. No. 15/311,633 published as US 2017/0087799, the content of which is incorporated herein by reference. Incorporating a phase change material of this type in the cold storage container avoids the risk of leakage and/or accessibility of the phase change material when in its liquid state; this facilitates use and safety. The phase change material may be in the form of a sheet, preferably a flexible sheet, for example a sheet having a thickness which is ≥3 mm, ≥4 mm, ≥5 mm or ≥7 mm and/or ≤15 mm or ≤12 mm. A thickness which is ≥4 mm and ≤6 mm provides a combination of good workability and good thermal performance, for example when used in a single thickness or in a double thickness. The phase change material preferably has a latent heat of fusion which is ≥100 J/g, ≥120 J/g and preferably ≥150 J/g; this provides an advantageous combination of thermal performance coupled with low weight. The latent heat of fusion of the phase change material may be ≤300 J/g or ≤250 J/g; this allow suitable performance without requiring the use of materials which are not readily available.

The use of a thermal barrier comprising a phase change material having a solid/liquid transition temperature which is ≥1.0° C. and ≤10° C. is fundamentally different from prior art proposals of using coolant packs which comprise phase change materials such as paraffin instead of ice-packs. In one of its aspects, the present invention provides a passive cold storage container, notably as defined in the claims, which uses ice-packs (which are water filled) and which thus have a solid/liquid transition temperature of about 0° C. In this aspect the invention uses the many advantage of ice-packs, for example their good thermal storage capacity, ease of handling, ready availability and wide-spread existing use, and improves upon this by providing a thermal barrier between the ice-pack(s) and a product storage compartment comprising a phase change material having a solid/liquid transition temperature which is ≥1.0° C. and ≤10° C. By arranging the solid/liquid transition temperature of the phase change material of the thermal barrier at a temperature which is ≥1.0° C. and ≤10° C., preferably ≥2° C. and ≤8° C., for example ≥3° C. and ≤7° C., it is believed that:

a) in a first step starting from a condition in which the cold storage container and the thermal barrier are at ambient temperature (eg 20° C.) and ice-packs (e.g. at −25° C.) are first inserted into the container, heat is removed from the phase change material and absorbed by the ice-pack(s) until the phase change material reaches its solid/liquid transition temperature;
b) subsequent absorption of heat by the ice-pack(s) removes latent heat of fusion from the phase change material but at a temperature of the phase change material which is in the range 1.0 to 10° C. i.e. a temperature which does not present a risk of freezing of the vaccines;
c) only once all latent heat of fusion has been removed from the phase change material can its temperature fall below its liquid/solid transition temperature but this is arranged so that, by this stage, the risk of freezing of the product storage compartment has been removed.
Furthermore, subsequent absorption of heat by the phase change material when the temperature inside the cold storage container rises to the liquid/solid transition temperature of the phase change material and heat is absorbed as the phase change material changes from a sold to a liquid, contributes to the cold life of the cold storage container.
This arrangement is also very different from prior art proposals of providing a freeze-preventive sleeve of water or salt water between the ice-packs and a vaccine storage compartment as, in this case, the sleeve of water is intended to act simply as a thermal absorber without a transition in phase from a liquid to a solid. Indeed, freezing such a water sleeve at about 0° C. or below would increase the risk of the vaccine storage compartment falling below 0° C.

The product storage compartment is preferably defined by a physical separator, for example provided by a liner or a cage; this helps ensure that the products are confined to a temperature optimised portion of the cold storage container. The product storage compartment may be provided in the form of a central air-filled column within the cold storage container; it may have a cross-section which is circular, square or polygonal. The cross-section may be constant or may taper, notably being larger at its top than at its base.

Providing the thermal barrier as a continuous barrier which separates the product storage compartment from the ice-pack compartment(s) and thus from the ice-pack(s) when in use, helps to avoid direct paths of heat transfer between the product storage compartment and the ice-packs; this helps to avoid cooling of any part of the product storage compartment below 0° C. Preferably, the configuration of the cold storage compartment, including the placement of the ice-packs and the placement of the products to be stored, promotes free circulation of air within the cold storage container and particularly within the product storage compartment so as to avoid temperature stratifications.

The thermal barrier may comprise one, two or more layers of thermal insulation, notably thermal insulating foam. A preferred insulating foam is polypropylene foam, particularly expanded polypropylene; expanded polystyrene and extruded polystyrene may also be used. The layer(s) of thermal insulation of the thermal barrier may have a thickness which is ≥3 mm and/or ≤15 mm; a thickness of about 10 mm is particularly suitable particularly due to its availability and easy of handling. The layer(s) of thermal insulation may be configured to reduce the speed of heat transfer from the product storage compartment to the ice-packs. This can contribute to avoiding the temperature of the product storage compartment falling below 0° C.

The thermal barrier may be provided with one of more vertical temperature distribution element, for example provided by a sheet or by strips of thermally conductive material, notably a metal. Aluminium or aluminium alloys are preferred for their combination of thermal conductivity, low weight and resistance to corrosion. The vertical temperature distribution element may be configured to facilitate heat transfer in the direction of the height of the cold storage container and thus to help avoid temperature stratification.

The cold storage container is particularly adapted for the storage of medical products in its product storage compartment. The medical products are preferably vaccines; alternatively, the products may be blood bags or biological samples or materials.

Embodiment of the inventions will now be described, by way of example only, with reference to the accompanying drawings, of which:

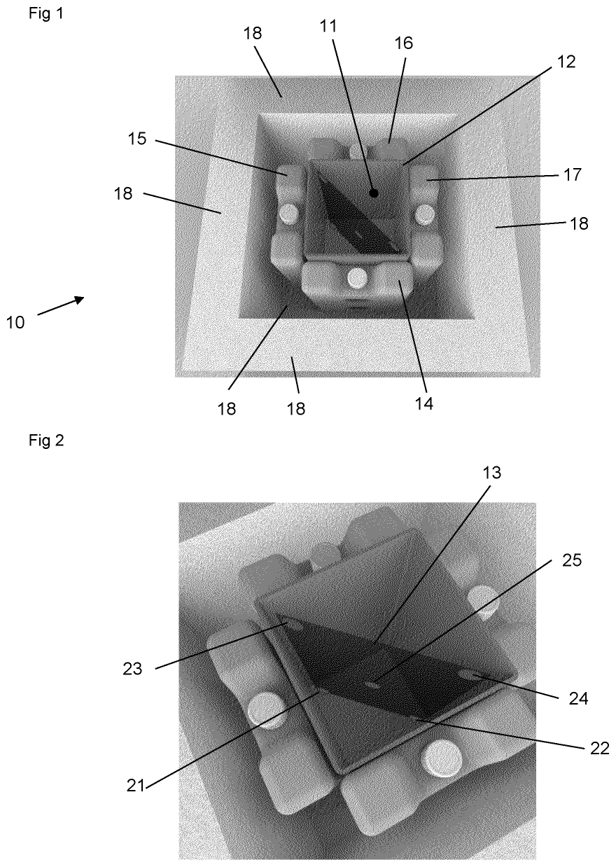

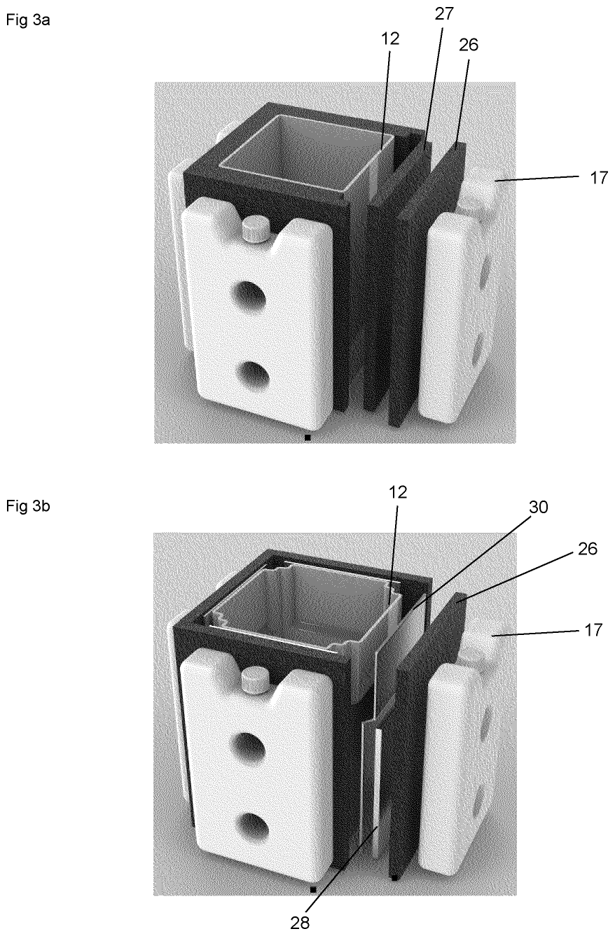

FIG. 1 and FIG. 2 are a perspective views of a test apparatus;

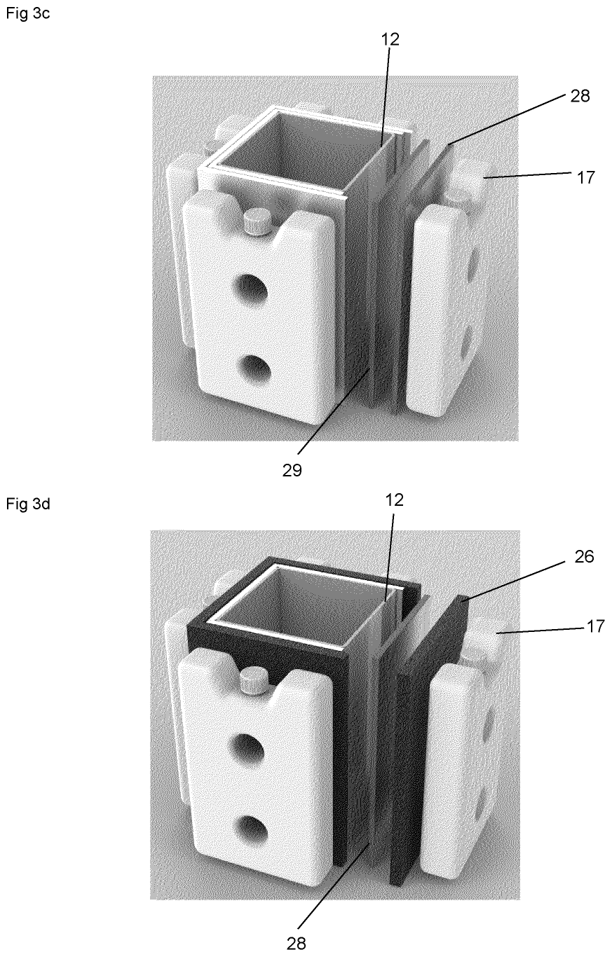

FIG. 3a, FIG. 3b, FIG. 3c and FIG. 3d are perspective, partially exploded views of thermal barriers tested;

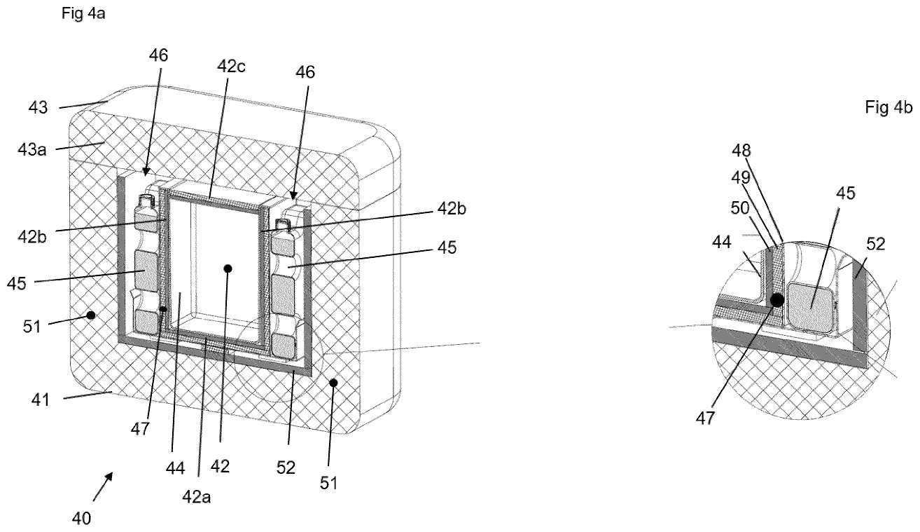

FIG. 4a is a cross section through a vaccine storage container and FIG. 4b is an enlarged view of a portion of FIG. 4a; and

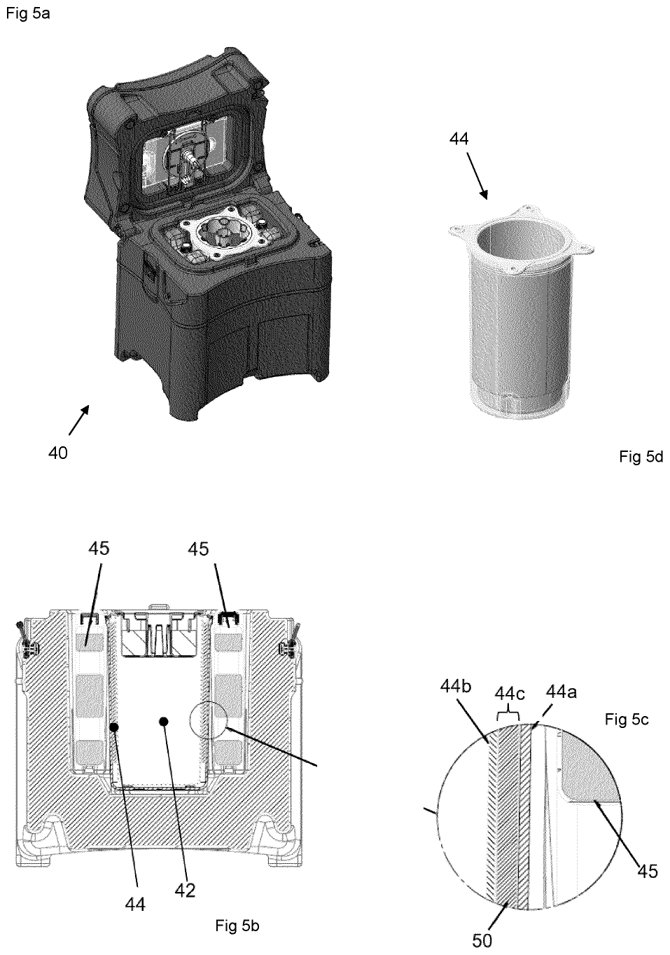

FIG. 5a is a perspective view of an alternative vaccine storage container, FIG. 5b is a cross section view of the base of this alternative vaccine storage container, FIG. 5c is an enlarged view of a portion of FIG. 5b and FIG. 5d is a perspective view of the sleeve used in this alternative vaccine storage container.

The test apparatus 10 illustrated in FIG. 1 and FIG. 2 comprises a simulated product storage compartment 11 defined within a sleeve 12. The sleeve had a square cross-section with rounded corners, cross-sectional dimensions of about 12 cm×12 cm and a height of about 19 cm; it was made of 2.5 mm thick PET. Temperature sensors 21, 22, 23, 24, 25 were arranged on a 1 mm thick PET support plate 13 arranged diagonally within the sleeve 12 to measure the temperature at the following positions within the product storage compartment 11: 21 bottom left corner; 22 bottom right corner, 23 top left corner; 24 top right corner; 25 centre. An individual 0.6 litre ice-pack 14, 15, 16, 17 was arranged against each of the four vertical, external walls of the sleeve 12. The sleeve 12 and the ice-packs 14, 15, 16, 17 were surrounded by a thermally insulated envelope provided by five 50 mm thick polyurethane insulating foam plates 18 glued together to form an open box with a sixth such insulating foam plate (not shown) being secured as a lid to the open box for the temperature monitoring tests. This arrangement simulates a passive vaccine carrier and was used to test the configurations of thermal barriers described below.

Each test was conducted by in the following way:

The test apparatus 10 was arranged in a test chamber whose temperature was maintained at the test temperature of +15.0° C. (±0.5° C.) or +43.0° C. (±0.5° C.)
Step 1: Stabilize the test apparatus 10 in the test chamber at the test temperature with the lid open.
Step 2: Fully freeze ice-packs 14, 15, 16, 17 at −25.0° C. (±0.5° C.); transfer the frozen ice-packs directly from their freezer to the test apparatus (without conditioning) and immediately close the lid of the test apparatus and start the temperature monitoring.
Step 3: Monitor the temperatures at one minute intervals.
The tests did not use a dummy vaccine load.

The thermal barriers tested are illustrated in the partially exploded views of FIGS. 3a to 3d.

In the FIG. 3a configuration, the thermal barrier comprised, in order from the ice packs to the product storage compartment 11: two layers 26, 27 of 10 mm thick expanded polypropylene foam insulation and the PET sleeve 12.

In the FIG. 3b configuration, the thermal barrier comprised, in order from the ice packs to the product storage compartment 11: a 10 mm thick expanded polypropylene foam insulation layer 26; a 5 mm thick layer of phase change material 28; a 2 mm thick aluminium plate 30, and the PET sleeve 12.

In the FIG. 3c configuration, the thermal barrier comprised, in order from the ice packs to the product storage compartment 11: two 5 mm thick layer of phase change material 28, 29 and the PET sleeve 12.

In the FIG. 3d configuration, the thermal barrier comprised, in order from the ice packs to the product storage compartment 11: a 10 mm thick expanded polypropylene foam insulation layer 26; a 5 mm thick layer of phase change material 28; and the PET sleeve 12.

In each configuration:
the thermal barrier provided a continuous, uninterrupted separation between the ice-packs 14, 15, 16, 17 and the product storage compartment 11;
each layer of polypropylene insulation 26,29 (when present) extended around the entire periphery of the product storage compartment 11 and over the full height of the product storage compartment 11;
the aluminium plate 30 (when present) extended around the entire periphery of the product storage compartment 11 and over the full height of the product storage compartment 11;
the layer(s) of phase change material (when present) had a liquid/solid transition temperature of about 5° C. and a latent heat of the fusion of about 180 J/g and comprised granulated of a paraffin- or wax-like nature retained in both solid and liquid states on a polymeric sheet network.
   In the configuration of FIG. 3b, the layer of phase change material 28 extended around the entire periphery of the product storage compartment 11 from the base of the product storage compartment 11 to a position about halfway up the vertical height of the product storage compartment 11.
   In the configurations of FIGS. 3c and 3d, the layer(s) of phase change material 28,29 extended around the entire periphery of the product storage compartment 11 and over the full height of the product storage compartment 11.

In the tables below, Table 1 shows test results at 15° C. and Table 2 shows test results at 43° C.

TABLE 1

| | Configuration tested at 15° C. | | | |
|---|---|---|---|---|
| | 3a | 3b | 3c | 3d |
| Lowest temperature of | −9.2° C. | 1.7° C. | 1.4° C. | 1.3° C. |
| any temperature sensor | | | | |

TABLE 2

| | Configuration tested at 43° C. | | | | | | | |
|---|---|---|---|---|---|---|---|---|
| | 3a | | 3b | | 3c | | 3d | |
| Lowest | 1.9° | C. | 7.3° | C. | 3.2° | C. | 4.7° | C. |
| temperature of | | | | | | | | |
| any tempera- | | | | | | | | |
| ture sensor | | | | | | | | |
| Cool down | <1 | h | <2 h 40 min | | <1 | h | <1 h 46 min | |
| (10° C.) | | | | | | | | |
| Cold life | >26 | hours | >26 | hours | >29 | hours | >28 | hours |
| (10° C.) | | | | | | | | |

As shown in Table 1, when tested at 15° C. the temperature in the product storage compartment of configurations 3b, 3c and 3d remained above 0.0° C.; these configurations were thus user-independent freeze-free when tested at 15° C. This was not the case for configuration 3a for which the temperature in the product storage compartment fell below 0.0° C.

Table 2 indicates that configuration 3c is particularly advantageous in terms of having both a long cold life and a rapid initial drop in the temperature of the products storage compartment to a temperature <10° C.

The passive vaccine storage container 40 illustrated in FIG. 4a and FIG. 4b comprises a base 41 which houses a vaccine storage compartment 42 and a removable lid 43. The product storage compartment 42 is an air-filled compartment whose base 42a and sidewalls 42b are defined by a plastics liner or cage 44 within which vials of vaccine (not shown) are placed for storage and transport. A top of the vaccine storage compartment 42 is preferably provided with a removable, insulated vaccine compartment lid 42c; alternatively, the lid 43 of the vaccine storage container 40 may provide a lid for the vaccine compartment 42. Ice-packs 45 are housed in ice-pack compartments 46 which are arranged adjacent to the vaccine storage compartment 42; the ice pack compartments 46 are spaced from the vaccine storage compartment 42 by a thermal barrier 47 which comprises, in order form the icepack compartment 46 to the product storage compartment 42: an aluminium plate 48 which provides a vertical temperature distribution element and which also serves to provide part of a housing for the thermal barrier 47 and for the ice-pack compartment 45; a layer of thermal insulation 49 and a layer of phase change material 50. The layer of thermal insulation 49 is provided by a self-supporting layer of foam insulation, for example having a thickness between 3 mm and 15 mm; the layer of phase change material 50 is preferably provided as a flexible, leak-free flexible sheet in which a phase change material is incorporated. A thermally insulating envelope 51, for example comprising PIR foam, is provided in the base 41 of the vaccine storage container 40 so as to surround the product storage compartment 42 and the ice-pack compartments 46. The thermally insulation envelope 47 may also comprises vaccine insulation panels 52, notably positioned adjacent to the ice-pack compartments 46 and adjacent to the base 42a of the vaccine storage compartment so as to provide an highly insulating inner lining of the thermally insulating envelope. The lid 43 of the vaccine storage container 40 is also provided with thermal insulation 43a, for example of PIR foam.

FIGS. 5a, 5b and 5c illustrate an alternative passive vaccine storage container 40 in which the vaccine storage compartment 42 is defined by a liner 44 having an inner sleeve 44a assembled with an outer sleeve 44b with a cavity 44c arranged between the inner 44a and outer 44b sleeves housing a thermal barrier comprising a sheet of phase change material 50 of the type as described in relation to FIGS. 4a and 4b.

### LIST OF REFERENCES

10 test apparatus
11 product storage compartment
12 sleeve
13 temperature sensor support plate
14 ice-pack
15 ice-pack
16 ice-pack
17 ice-pack
18 insulating foam plates
21 temperature sensor
22 temperature sensor
23 temperature sensor
24 temperature sensor
25 temperature sensor
26 expanded polypropylene insulation
27 expanded polypropylene insulation
28 phase change material
29 phase change material
30 aluminium plate
40 passive vaccine storage container;
41 base
42 vaccine storage compartment;
42a base of vaccine storage compartment
42b sidewalls vaccine storage compartment
42c vaccine compartment lid
43 lid of vaccine storage container
43a thermal insulation of lid
44 liner or cage
44a inner sleeve of liner
44b outer sleeve of liner
44c cavity
45 ice-pack
46 ice-pack compartment
47 thermal barrier
48 temperature distribution element
49 thermal insulation
50 phase change material
51 thermally insulating envelope
52 vaccine insulation panels

1-15. (canceled)

16. A passive cold storage container comprising:
a product storage compartment;
one or more ice-pack compartment(s) arranged adjacent to the product storage compartment, the ice-pack compartment(s) being spaced from the product storage compartment by a thermal barrier; and
a thermally insulated envelope surrounding the product storage compartment and the ice-pack compartment(s);
wherein
the thermal barrier comprises a phase change material having a solid/liquid transition temperature which is 1.0° C. and 10° C.; and
the phase change material comprises a self-supporting sheet of phase change material comprising a phase change polymer retained when in its liquid state by a supporting fibre structure and having the form of a flexible sheet having a thickness in the range 3 mm to 15 mm; and
the thermal barrier comprises: the phase change material provided in the form of a first layer; and a layer of thermal insulation provided by insulating foam provided in the form of a second layer.

17. The passive cold storage container of claim 16,
wherein the thermal barrier further comprises a vertical temperature distribution element of a thermally conductive material.

18. The passive cold storage container of claim 17,
wherein the vertical temperature distribution element is provided by a sheet of metal.

19. The passive cold storage container of claim 17,
wherein the thermal barrier comprises, in order, from the ice-pack compartment(s) to the product storage compartment:
the vertical temperature distribution element;
the layer of thermal insulation; and
the layer of phase change material.

20. The passive cold storage container of claim 16,
wherein the cold storage container is a Grade A (user-independent) freeze protected storage container as defined by the World Health Organisation PQS requirements in force on 1 Jun. 2019.

21. A passive cold storage container comprising:
a product storage compartment;
one or more ice-pack compartment(s) arranged adjacent to the product storage compartment, the ice-pack compartment(s) being spaced from the product storage compartment by a thermal barrier; and
a thermally insulated envelope surrounding the product storage compartment and the ice-pack compartment(s);
wherein
the thermal barrier comprises a phase change material having a solid/liquid transition temperature which is 1.0° C. and 10° C.; and
the phase change material comprises a self-supporting sheet of phase change material comprising a phase change polymer retained in its liquid state by a supporting fibre structure.

22. The passive cold storage container of claim 21,
wherein the phase change material is the form of a flexible sheet having a thickness in the range 3 mm to 15 mm.

23. The passive cold storage container of claim 22,
wherein the product storage compartment is provided in the form of a central air-filled column within the cold storage container and has a circular cross-section.

24. The passive cold storage container of claim 21,
wherein the phase change material has a latent heat of fusion in the range 100 J/g to 300 J/g.

25. The passive cold storage container of claim 21,
wherein the thermal barrier comprises:
the phase change material provided in the form of a first layer and a layer of thermal insulation provided by insulating foam provided in the form of a second layer.

26. The passive cold storage container of claim 25,
wherein the thermal barrier comprises a vertical temperature distribution element of a thermally conductive material provided by a sheet of metal.

27. A passive cold storage container comprising:
a product storage compartment;
one or more ice-pack compartment(s) arranged adjacent to the product storage compartment, the ice-pack compartment(s) being spaced from the product storage compartment by a thermal barrier; and
a thermally insulated envelope surrounding the product storage compartment and the ice-pack compartment(s);
wherein
the thermal barrier comprises a phase change material having a solid/liquid transition temperature which is 1.0° C. and 10° C.; and
the thermal barrier comprises a vertical temperature distribution element of a thermally conductive material provided by a sheet of metal.

28. The passive cold storage container of claim 27,
wherein the thermal barrier provides a continuous barrier which separates the product storage compartment from the ice-pack compartment(s); and
wherein the thermal barrier further comprises the phase change material provided in the form of a first layer and a layer of thermal insulation provided by insulating foam and provided in the form of a second layer.

29. The passive cold storage container of claim 28,
wherein the thermal barrier comprises, in order, from the ice-pack compartment(s) to the product storage compartment:
the vertical temperature distribution element;
the layer of thermal insulation; and
the layer of phase change material.

30. The passive cold storage container of claim 27,
wherein the phase change material comprises a self-supporting sheet of phase change material comprising a phase change polymer retained in its liquid state by a supporting fibre structure.

31. The passive cold storage container of claim 30,
wherein the product storage compartment is provided in the form of a central air-filled column within the cold storage container and has a circular cross-section.

32. The passive cold storage container of claim 16,
wherein the phase change material has a solid/liquid transition temperature which is ≥2° C. and ≤8° C.

33. The passive cold storage container of claim 16,
wherein the product storage compartment contains vaccines.

34. The passive cold storage container of claim 21,
wherein the cold storage container is a Grade A (user-independent) freeze protected storage container as defined by the World Health Organisation PQS requirements in force on 1 Jun. 2019.
